(19) United States
(12) Patent Application Publication
(10) Pub. No.: US 2005/0013221 A1
(43) Pub. Date: Jan. 20, 2005

(54) Optical disk apparatus and optical disk processing method

(75) Inventor: Takanobu Sato, Tokyo (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/866,724

(22) Filed: Jun. 15, 2004

(30) Foreign Application Priority Data
Jul. 15, 2003 (JP) 2003-197398

(51) Int. Cl. G11B 7/00; G11B 5/09

(52) U.S. Cl. 369/47.44; 369/44.32; 369/53.19

(57) ABSTRACT

In an optical disk processing method according an aspect of the present invention, an optical disk is irradiated with a light beam, the amount of reflected light from the optical disk is detected, and the warp amount of the optical disk is detected on the basis of the detected amount of the reflected light.

### CROSS-REFERENCE TO RELATED APPLICATIONS

This application is based upon and claims the benefit of priority from prior Japanese Patent Application No. 2003-197398, filed Jul. 15, 2003, the entire contents of which are incorporated herein by reference.

### BACKGROUND OF THE INVENTION

1. Field of the Invention

The present invention relates to an optical disk apparatus which records or plays back information on or from an optical disk by irradiating the optical disk with a light beam.

2. Description of the Related Art

Along with the recent increase in density of digital information storage media such as an optical disk, extensive research and development have been conducted on improving the record/playback accuracy by an optical disk drive. In a technique disclosed in, e.g., Jpn. Pat. Appln. KOKAI Publication No. 7-98943, if error correction becomes impossible during data playback and should be executed again, retry is done after switching the rotational speed of the disk to ×1 read rate.

Independently of occurrence of the above-described error uncorrectable state, an optical disk has a medium characteristic called “warp”, as is known. There is also a problem of recording errors caused by a warp (medium characteristic) of an optical disk.

### BRIEF SUMMARY OF THE INVENTION

According to an aspect of the present invention, there is provided an optical disk apparatus comprising a rotational driving unit configured to rotationally drive an optical disk, an irradiation unit configured to irradiate, with a light beam, the optical disk rotationally driven by the rotational driving unit, a reflected light amount detection unit configured to detect an amount of reflected light from the optical disk, and a warp amount detection unit configured to detect a warp amount of the optical disk on the basis of the amount of the reflected light detected by the reflected light amount detection unit.

According to another aspect of the present invention, there is provided an optical disk processing method comprising irradiating an optical disk with a light beam, detecting an amount of reflected light from the optical disk, and detecting a warp amount of the optical disk on the basis of the detected amount of the reflected light.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a block diagram showing the schematic arrangement of an optical disk apparatus according to an embodiment of the present invention;

FIG. 2 is a plan view showing the schematic arrangement of the optical pickup head shown in FIG. 1;

FIG. 3 is a side view of the optical pickup head shown in FIG. 1;

FIG. 4 is a graph showing the effect of recording processing by rotational speed control using the detection result of an optical disk warp amount;

FIG. 5 is a graph showing the relationship between the reflectance and the distance (address) from the center of an optical disk having a relatively small warp amount;

FIG. 6 is a graph showing the relationship between the reflectance and the distance (address) from the center of an optical disk having a relatively large warp amount;

FIG. 7 is a flowchart for explaining recording processing by rotational speed control using the detection result of an optical disk warp amount; and

FIG. 8 is a flowchart for explaining recording processing by recording power control using the detection result of an optical disk warp amount.

### DETAILED DESCRIPTION OF THE INVENTION

The embodiment of the present invention will be described below with reference to the accompanying drawing.

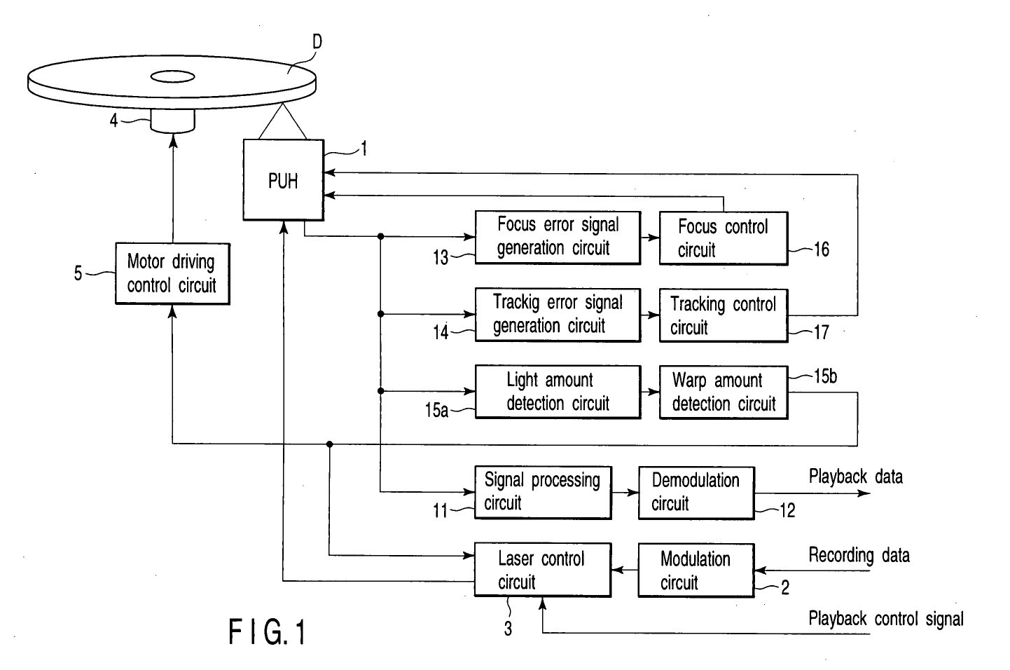

FIG. 1 is a block diagram showing the schematic arrangement of an optical disk apparatus according to an embodiment of the present invention. This optical disk apparatus records target data on an optical disk D such as a DVD or CD or plays back data recorded on the optical disk D.

As shown in FIG. 1, the optical disk apparatus comprises an optical pickup head (PUH) 1, modulation circuit 2, laser control circuit 3, spindle motor 4, motor driving control circuit 5, signal processing circuit 11, demodulation circuit 12, focus error signal generation circuit 13, tracking error signal generation circuit 14, light amount detection circuit 15a, warp amount detection circuit 15b, focus control circuit 16, and tracking control circuit 17.

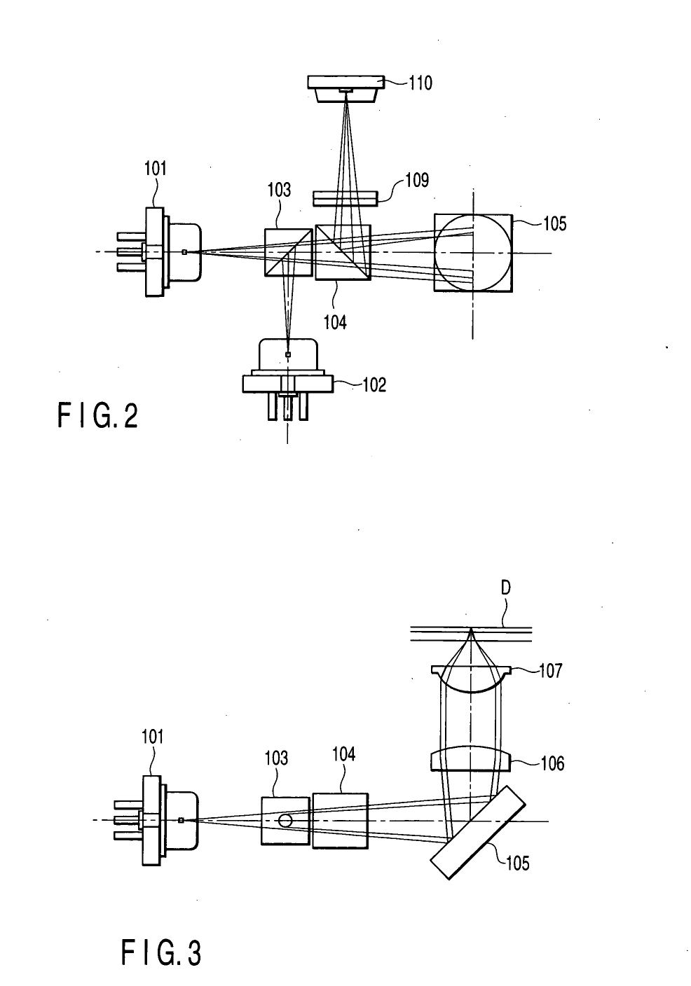

FIG. 2 is a plan view showing the schematic arrangement of the optical pickup head 1 shown in FIG. 1. FIG. 3 is a side view of the optical pickup head 1 shown in FIG. 1. Both the plan view shown in FIG. 2 and the side view shown in FIG. 3 partially omit the structure of the optical pickup head 1 for the illustrative convenience.

As shown in FIGS. 2 and 3, the optical pickup head comprises a DVD laser 101, CD laser 102, dichroic mirror 103, polarizing beam splitter (PBS) 104, mirror 105, collimator lens 106, objective lens 107, detection lens 109, and optical detection element 110.

A case wherein a DVD as an example of the optical disk is processed will be described first. The DVD laser 101 emits a first light beam having a first wavelength (e.g., about 650 nm). The first light beam emitted from the DVD laser 101 passes through the dichroic mirror 103 and the polarizing beam splitter 104. The first light beam that has passed through the polarizing beam splitter 104 is reflected upward by the mirror 105. The first light beam reflected upward by the mirror 105 is collimated into a parallel beam by the collimator lens 106 and focused on the recording surface of the optical disk (DVD) through the objective lens 107. By thus focusing the light beam (focusing the first light beam having a predetermined recording power), information can be recorded on the optical disk (DVD).

In the playback mode, reflected light from the optical disk, i.e., first reflected light obtained from the optical disk in correspondence with the first light beam is reflected by the collimator lens 106 and mirror 105 and is polarized by the polarizing beam splitter 104. The first reflected light polarized by the polarizing beam splitter 104 is detected by the optical detection element 110 through the detection lens 109. On the basis of the first reflected light (the reflected light of the first light beam having a predetermined playback power) detected by the optical detection element 110, information recorded on the optical disk (DVD) is played back, and tracking and focus are controlled. Tracking control and focus control will be described later in detail.

A case wherein a CD as an example of the optical disk is processed will be described next. The CD laser 102 emits a second light beam having a second wavelength (e.g., about 780 nm) longer than the first wavelength. The second light beam emitted from the CD laser 102 is reflected by the dichroic mirror 103 and passes through the polarizing beam splitter 104. The second light beam that has passed through the polarizing beam splitter 104 is raised by the mirror 105. The second light beam raised by the mirror 105 is collimated into a parallel beam by the collimator lens 106 and focused on the recording surface of the optical disk (CD) through the objective lens 107. By thus focusing the light beam (focusing the second light beam having a predetermined recording power), information can be recorded on the optical disk (CD).

In the playback mode, reflected light from the optical disk, i.e., second reflected light obtained from the optical disk in correspondence with the second light beam is reflected by the collimator lens 106 and mirror 105 and is polarized by the polarizing beam splitter 104. The second reflected light polarized by the polarizing beam splitter 104 is detected by the optical detection element 110 through the detection lens 109. On the basis of the second reflected light (the reflected light of the second light beam having a predetermined playback power) detected by the optical detection element 110, information recorded on the optical disk (CD) is played back, and tracking and focus are controlled. Tracking control and focus control will be described later in detail.

Data recording on the optical disk D by the optical disk apparatus having the above-described arrangement will be described next with reference to the block diagram shown in FIG. 1. A recording signal is modulated to a signal of a predetermined channel bit sequence by the modulation circuit 2. The channel bit sequence corresponding to the recording signal is converted into a laser driving waveform by the laser control circuit 3. The laser control circuit 3 pulse-drives the DVD laser 101 or CD laser 102 to cause it to emit a light beam having a recording power. As a result, the light beam having the recording power is focused on the information recording surface of the optical disk D so that target data is recorded on the optical disk D. At this time, the light beam for recording, which is focused on the optical disk D, is maintained in a state capable of obtaining the best microspot on the recording surface by focus control by the focus control circuit 16 and tracking control by the tracking control circuit 17.

Playback of data recorded on the optical disk D by the optical disk apparatus will be described next with reference to the block diagram shown in FIG. 1. On the basis of a data playback instruction, the laser control circuit 3 drives the DVD laser 101 or CD laser 102 to cause it to emit a light beam having a playback power. As a result, the light beam having the playback power is focused on the information recording surface of the optical disk D. The light beam having the playback power, which is focused on the optical disk D, is maintained in a state capable of obtaining the best microspot on the recording surface by focus control by the focus control circuit 16 and tracking control by the tracking control circuit 17. At this time, the light beam having the playback power, with which the surface of the optical disk D is irradiated, is reflected by a reflecting film or reflective recording film in the information recording surface. The reflected light is detected by the optical detection element 110. The optical detection element 110 has, e.g., four photodetection areas. The light beam which becomes incident on the optical detection element 110 is photoelectrically converted into an electrical signal and amplified. The amplified signal is equalized and binarized by the signal processing circuit 11 and sent to the demodulation circuit 12. The demodulation circuit 12 executes a demodulation operation corresponding to a predetermined modulation method and outputs playback data.

On the basis of part of the electrical signal output from the optical detection element 110, the focus error signal generation circuit 13 generates a focus error signal. Similarly, on the basis of part of the electrical signal output from the optical detection element 110, the tracking error signal generation circuit 14 generates a tracking error signal. The focus control circuit 16 controls the focus of the beam spot on the basis of the focus error signal. The tracking control circuit 17 controls the tracking of the beam spot on the basis of the tracking error signal.

In addition, on the basis of the electrical signal output from the optical detection element 110, the light amount detection circuit 15a detects the reflected light amount. On the basis of the reflected light amount detection result by the light amount detection circuit 15a, the warp amount detection circuit 15b detects the warp amount of the optical disk.

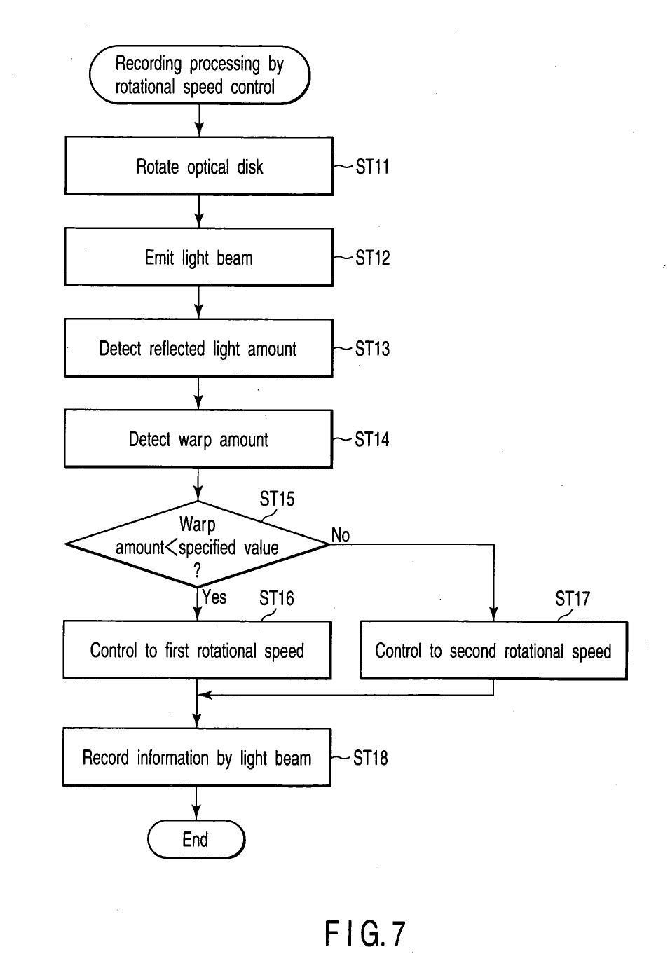

FIG. 5 is a graph showing the relationship between the reflectance and the distance (address) from the center of an optical disk having a relatively small warp amount. FIG. 6 is a graph showing the relation-ship between the reflectance and the distance (address) from the center of an optical disk having a relatively large warp amount. As shown in FIG. 5, the reflectance from the optical disk having a relatively small warp amount is relatively constant. To the contrary, as shown in FIG. 6, the reflectance from the optical disk having a relatively large warp amount partially largely varies. That is, when the warp amount increases, the reflectance becomes low. As a result, the reflected light amount decreases. By using this principle, the warp amount detection circuit 15b detects the warp amount on the basis of the reflected light amount detection result by the light amount detection circuit 15a. That is, the warp amount detection circuit 15b detects large and small of the warp amount in correspondence with strong and weak of the reflected light. Recording processing by rotational speed control using the detection result of an optical disk warp amount will be described next with reference to the flowchart shown in FIG. 7.

First, the motor driving control circuit 5 controls the drive of the spindle motor 4 so that the optical disk is rotated at a predetermined speed (ST11). At this time, the DVD laser 101 or CD laser 102 emits a light beam having a predetermined power under the control of the laser control circuit 3 (ST12). In response to this, the light amount detection circuit 15a detects the reflected light amount (ST13), and the warp amount detection circuit 15b detects the warp amount (ST14).

If the warp amount detected by the warp amount detection circuit 15b is smaller than a specified value (YES in ST15), the motor driving control circuit 5 controls the drive of the spindle motor 4 to control the rotational speed of the optical disk to the first rotational speed (e.g., ×24 read rate) (ST16). If the warp amount detected by the warp amount detection circuit 15b is equal to or larger than the specified value (NO in ST15), the motor driving control circuit 5 controls the drive of the spindle motor 4 to control the rotational speed of the optical disk to the second rotational speed (e.g., ×1 read rate) lower than the first rotational speed (ST17). Information is recorded on the optical disk, whose rotational speed is controlled by the motor driving control circuit, by the light beam having the predetermined recording power, which is emitted from the DVD laser 101 or CD laser 102 (ST18).

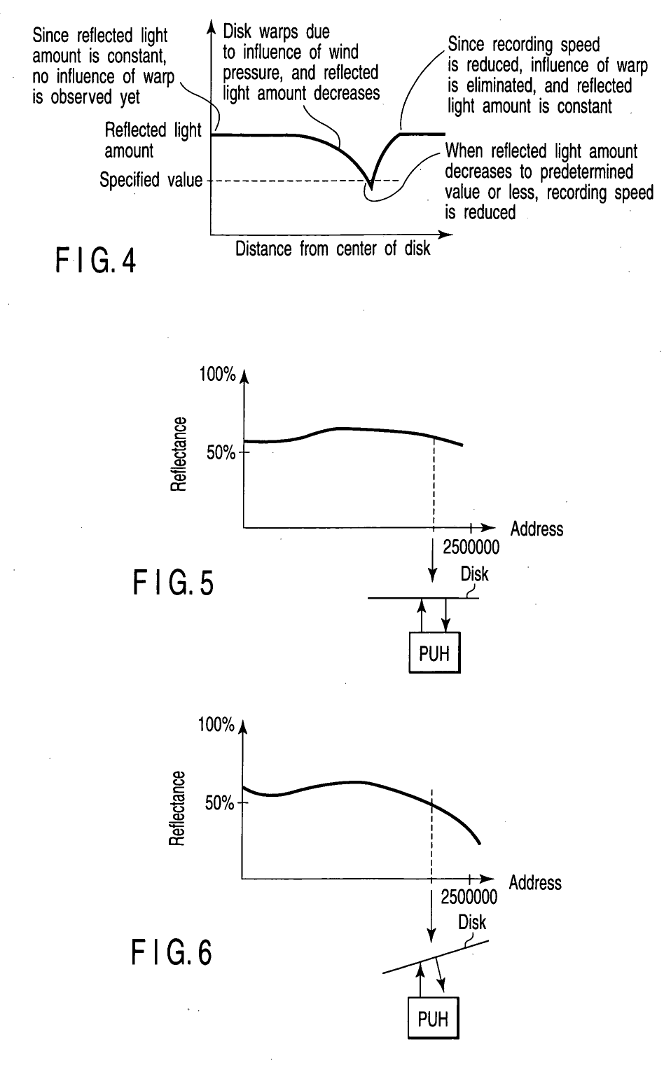

The effect shown in FIG. 4 is obtained by the above-described recording processing by rotational speed control using the detection result of the optical disk warp amount. For example, assume that recording is to be sequentially executed from the inner periphery to the outer periphery of an optical disk which has a relatively large warp at the outer periphery. The warp at the inner periphery of the disk is relatively small. That is, the distance between the optical pickup head 1 and the recording surface at the inner periphery of the disk is almost constant, and the reflected light amount is also almost constant. As the recording position moves from the inner periphery to the outer periphery, the reflected light amount decreases due to the influence of the warp. That is, the distance between the optical pickup head 1 and the recording surface at the outer periphery with the warp tends to increase. Consequently, the laser power transmitted from the optical pickup head 1 to the optical disk decreases. As the recording position further moves to the outer periphery, the warp amount is expected to increase. As a result, a recording error occurs at a high probability. To prevent any recording error, the recording speed, i.e., the rotational speed is reduced when the reflected light amount becomes smaller than the specified value. When the recording speed is low, the influence of the warp of the disk is small. The reflected light amount that has decreased also returns to a normal level.

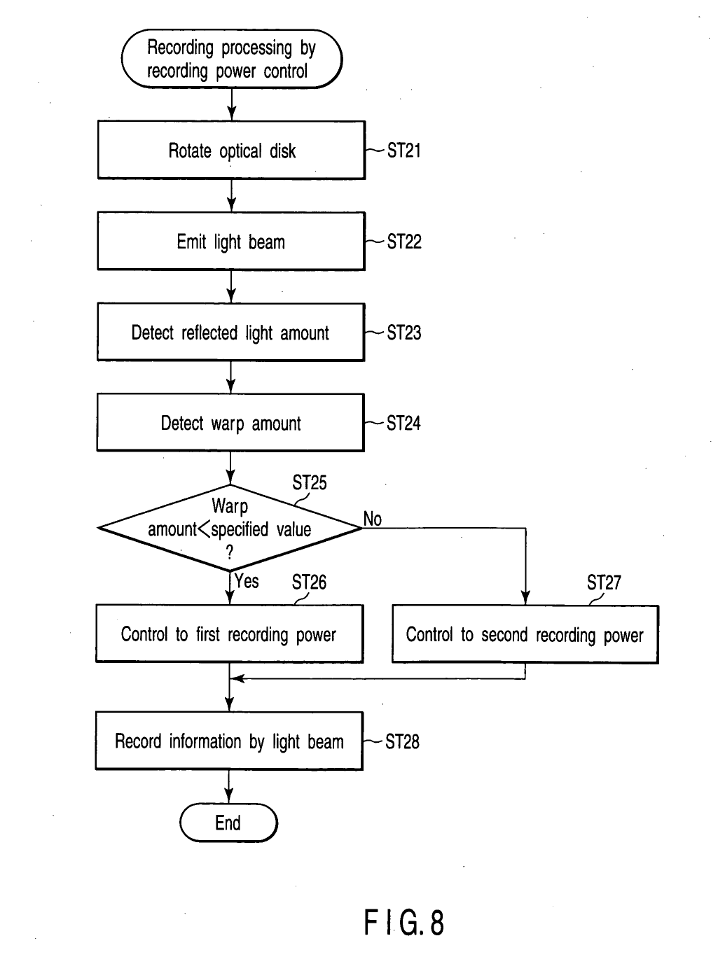

Recording processing by recording power control using the detection result of an optical disk warp amount will be described next with reference to the flowchart shown in FIG. 8.

First, the motor driving control circuit 5 controls the drive of the spindle motor 4 so that the optical disk is rotated at a predetermined speed (ST21). At this time, the DVD laser 101 or CD laser 102 emits a light beam having a predetermined power under the control of the laser control circuit 3 (ST22). In response to this, the light amount detection circuit 15a detects the reflected light amount (ST23), and the warp amount detection circuit 15b detects the warp amount (ST24).

If the warp amount detected by the warp amount detection circuit 15b is smaller than a specified value (YES in ST25), the laser control circuit 3 controls the recording power of the DVD laser 101 or CD laser 102 to a first recording power (ST26). If the warp amount detected by the warp amount detection circuit 15b is equal to or larger than the specified value (NO in ST25), the laser control circuit 3 controls the recording power of the DVD laser 101 or CD laser 102 to a second recording power higher than the first recording power (ST27). Information is recorded on the optical disk by the light beam whose recording power is controlled by the laser control circuit 3 (ST28).

As described above, according to the present invention, any recording error caused by the warp of a disk can be prevented. The warp of a disk and a recording error will be described in more detail. It is confirmed that when a disk is played back at ×24 read rate by a 9.5-mm thick slim drive, the disk warps due to the influence of the wind pressure. Especially, the warp is larger at the outer periphery than at the inner periphery. For this reason, the playback accuracy at the outer periphery of the disk is lower than that at the inner periphery, though stop of playback or a servo error rarely occurs at the outer periphery. In the recording mode, however, a write error can occur due to the warp. Especially, when data is recorded on a medium of poor quality at ×24 read rate, the recording quality at the outer periphery may be considerably poor even when recording is possible. In the present invention, as described above, the reflected light amount is monitored. When the reflected light amount abruptly changes (when the reflected light amount is smaller than a specified value), the rotational speed is reduced from the current speed, or the recording power is increased from the current power. Accordingly, the influence of warp can be reduced, and stable recording can be executed.

Only recording processing by rotational speed control based on the warp amount detection result and recording processing by recording power control based on the warp amount detection result have been described above. However the present invention is not limited to recording processing and can also be applied to, e.g., playback processing.

More specifically, if the warp amount detected by the warp amount detection circuit 15b is smaller than a specified value, the motor driving control circuit 5 controls the drive of the spindle motor 4 to control the rotational speed of the optical disk to the first rotational speed (e.g., ×24 read rate). If the warp amount detected by the warp amount detection circuit 15b is equal to or larger than the specified value, the motor driving control circuit 5 controls the drive of the spindle motor 4 to control the rotational speed of the optical disk to the second rotational speed (e.g., ×1 read rate) lower than the first rotational speed. Information recorded on the optical disk, whose rotational speed is controlled by the motor driving control circuit, is played back by the light beam having the predetermined recording power, which is emitted from the DVD laser 101 or CD laser 102. Alternatively, if the warp amount detected by the warp amount detection circuit 15b is smaller than a specified value, the laser control circuit 3 controls the recording power of the DVD laser 101 or CD laser 102 to a first recording power. If the warp amount detected by the warp amount detection circuit 15b is equal to or larger than the specified value, the laser control circuit 3 controls the recording power of the DVD laser 101 or CD laser 102 to a second recording power higher than the first recording power. Information recorded on the optical disk is played back by the light beam whose recording power is controlled by the laser control circuit 3.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. An optical disk apparatus comprising:
a rotational driving unit configured to rotationally drive an optical disk;
an irradiation unit configured to irradiate, with a light beam, the optical disk rotationally driven by the rotational driving unit;
a reflected light amount detection unit configured to detect an amount of reflected light from the optical disk; and
a warp amount detection unit configured to detect a warp amount of the optical disk on the basis of the amount of the reflected light detected by the reflected light amount detection unit.

2. An apparatus according to claim 1, further comprising
a rotational speed control unit configured to control a rotational speed of the optical disk on the basis of the warp amount detected by the warp amount detection unit, and
a recording unit configured to record information on the optical disk, whose rotational speed is controlled by the rotational speed control unit, by the light beam with which the optical disk is irradiated by the irradiation unit.

3. An apparatus according to claim 1, further comprising
a rotational speed control unit configured to control a rotational speed of the optical disk to a first rotational speed when the warp amount detected by the warp amount detection unit is less than a specified amount and control the rotational speed of the optical disk to a second rotational speed lower than the first rotational speed when the warp amount detected by the warp amount detection unit is not less than the specified amount, and
a recording unit configured to record information on the optical disk, whose rotational speed is controlled by the rotational speed control unit, by the light beam with which the optical disk is irradiated by the irradiation unit.

4. An apparatus according to claim 1, further comprising
a recording power control unit configured to control a recording power of the light beam, with which the optical disk is irradiated, on the basis of the warp amount detected by the warp amount detection unit, and
a recording unit configured to record information on the optical disk by the light beam whose recording power is controlled by the recording power control unit.

5. An apparatus according to claim 1, further comprising
a recording power control unit configured to control a recording power of the light beam, with which the optical disk is irradiated, to a first recording power when the warp amount detected by the warp amount detection unit is less than a specified amount and control the recording power of the light beam, with which the optical disk is irradiated, to a second recording power higher than the first recording power when the warp amount detected by the warp amount detection unit is not less than the specified amount, and
a recording unit configured to record information on the optical disk by the light beam whose recording power is controlled by the recording power control unit.

6. An apparatus according to claim 1, wherein the warp amount detection unit detects large and small of the warp amount in correspondence with strong and weak of the reflected light.

7. An optical disk processing method comprising:
irradiating an optical disk with a light beam;
detecting an amount of reflected light from the optical disk; and
detecting a warp amount of the optical disk on the basis of the detected amount of the reflected light.

8. A method according to claim 7, further comprising
controlling a rotational speed of the optical disk on the basis of the detected warp amount, and
recording information on the optical disk, whose rotational speed is controlled, by the light beam.

9. A method according to claim 7, further comprising
controlling a rotational speed of the optical disk to a first rotational speed when the detected warp amount is less than a specified amount and controlling the rotational speed of the optical disk to a second rotational speed lower than the first rotational speed when the detected warp amount is not less than the specified amount, and
recording information on the optical disk, whose rotational speed is controlled, by the light beam.

10. A method according to claim 7, further comprising
controlling a recording power of the light beam, with which the optical disk is irradiated, on the basis of the detected warp amount, and
recording information by the light beam whose recording power is controlled.

11. A method according to claim 7, further comprising
controlling a recording power of the light beam, with which the optical disk is irradiated, to a first recording power when the detected warp amount is less than a specified amount and controlling the recording power of the light beam, with which the optical disk is irradiated, to a second recording power higher than the first recording power when the detected warp amount is not less than the specified amount, and
recording information by the light beam whose recording power is controlled.

12. A method according to claim 7, wherein large and small of the warp amount are detected in correspondence with strong and weak of the reflected light.
